(19) United States
(12) Patent Application Publication
(10) Pub. No.: US 2006/0222206 A1
(43) Pub. Date: Oct. 5, 2006

(54) Intelligent video behavior recognition with multiple masks and configurable logic inference module

(75) Inventor: Maurice V. Garoutte, Dittmer, MO (US)

Correspondence Address: GREENSFELDER HEMKER & GALE PC, SUITE 2000, 10 SOUTH BROADWAY, ST LOUIS, MO, 63102, US

(73) Assignee: CERNIUM, INC., St. Louis, MO (US)

(21) Appl. No.: 11/393,046

(22) Filed: Mar. 30, 2006

Related U.S. Application Data
(60) Provisional application No. 60/666,429, filed on Mar. 30, 2005.

(51) Int. Cl. G06K 9/00

(52) U.S. Cl. 382/103

(57) ABSTRACT

Methodology of implementing complex behavior recognition in an intelligent video system includes multiple event detection defining activity in different areas of the scene (“What”), multiple masks defining areas of a scene (“Where”), configurable time parameters (“When”), and a configurable logic inference engine to allow Boolean logic analysis based on any combination of logic-defined events and masks. Events are detected in a video scene that consists of one or more camera views termed a “virtual view”. The logic-defined event is a behavioral event connoting behavior, activities, characteristics, attributes, locations and/or patterns of a target subject of interest. A user interface allows a system user to select behavioral events for logic definition by the Boolean equation in accordance with a perceived advantage, need or purpose arising from context of system use.

### CROSS-REFERENCE TO RELATED APPLICATION

This application claims the priority of U.S. provisional patent application Ser. No. 60/666,429, filed Mar. 30, 2005, entitled INTELLIGENT VIDEO BEHAVIOR RECOGNITION WITH MULTIPLE MASKS AND CONFIGURABLE LOGIC INFERENCE MODULE.

### FIELD OF THE INVENTION

The invention relates to the field of intelligent video surveillance and, more specifically, to a surveillance system that analyzes the behavior of objects such as people and vehicles moving in a video scene.

Intelligent video surveillance connotes the use of processor-driven, that is, computerized video surveillance involving automated screening of security cameras, as in security CCTV (Closed Circuit Television) systems.

### BACKGROUND OF THE INVENTION

The invention makes use of Boolean logic. Boolean logic is the invention of George Boole (1815-1864) and is a form of algebra in which all values are reduced to either True or False. Boolean logic symbolically represents relationships between entities. There are three Boolean operators AND, OR and NOT, which may be regarded and implemented as “gates.” Thus, it provides a process of analysis that defines a rigorous means of determining a binary output from various gates for any combination of inputs. For example, an AND gate will have a True output only if all inputs are true while an OR gate will have a True output if any input is True. So also, a NOT gate will have a True output if the input is not True. A NOR gate can also be defined as a combination of an OR gate and a NOT gate. So also, a NAND gate is defined as a combination of a NOT gate and an AND gate. Further gates that can be considered are XOR and XNOR gates, known respectively as “exclusive OR” and “exclusive NOR” gates, which can be realized by assembly of the foregoing gates.

Boolean logic is compatible with binary logic. Thus, Boolean logic underlies generally all modern digital computer designs including computers designed with complex arrangements of gates allowing mathematical operations and logical operations.

Logic Inference Module

A configurable logic inference engine is a software implementation in the present system to allow a user to set up a Boolean logic equation based on high-level descriptions of inputs, and to solve the equation without requiring the user to understand the notation, or even the rules of the underlying logic.

Such a logic inference engine is highly useful in the system of a copending patent application owned by the present applicant's assignee/intended assignee, namely application Ser. No. 09/773,475, filed Feb. 1, 2001, published as Pub. No.: US 2001/0033330 A1, Pub. Date: Oct. 25, 2001, entitled System for Automated Screening of Security Cameras, and corresponding International Patent Application PCT/US01/03639, of the same title, filed Feb. 5, 2001, both also called a security system, and hereinafter referred to the PERCEPTRAK disclosure or system, and herein incorporated by reference. That system may be identified by the trademark PERCEPTRAK herein. PERCEPTRAK is a registered trademark (Regis. No. 2,863,225) of Cernium, Inc., applicant's assignee/intended assignee, to identify video surveillance security systems, comprised of computers; video processing equipment, namely a series of video cameras, a computer, and computer operating software; computer monitors and a centralized command center, comprised of a monitor, computer and a control panel. Events in the PERCEPTRAK system described in said application Ser. No. 09/773,475 are defined as:
Contact closures from external systems;
Message receipt from an external system;
A behavior recognition event from the intelligent video system;
A system defined exception; and
A defined time of day.

Software-driven processing of the PERCEPTRAK system performs a unique function within the operation of such system to provide intelligent camera selection for operators, resulting in a marked decrease of operator fatigue in a CCTV system. Real-time video analysis of video data is performed wherein a single pass or at least one pass of a video frame produces a terrain map which contains elements termed primitives which are low level features of the video. Based on the primitives of the terrain map, the system is able to make decisions about which camera an operator should view based on the presence and activity of vehicles and pedestrians and furthermore, discriminates vehicle traffic from pedestrian traffic. The PERCEPTRAK system provides a processor-controlled selection and control system (“PCS system”), serving as a key part of the overall security system, for controlling selection of the CCTV cameras. The PERCEPTRAK PCS system is implemented to enable automatic decisions to be made about which camera view should be displayed on a display monitor of the CCTV system, and thus watched by supervisory personnel, and which video camera views are ignored, all based on processor-implemented interpretation of the content of the video available from each of at least a group of video cameras within the CCTV system.

Thus, the PERCEPTRAK system uses video analysis techniques which allow the system to make decisions automatically about which camera an operator or security guard should view based on the presence and activity of vehicles and pedestrians, as examples of subjects of interest. Events, e.g., activities or attributes, are associated with subjects of interest, including both vehicles and pedestrians, as primary examples. They include, but are not limited to, single pedestrian, multiple pedestrians, fast pedestrian, fallen pedestrian, lurking pedestrian, erratic pedestrian, converging pedestrians, single vehicle, multiple vehicles, fast vehicles, and sudden stop vehicle. More is said about them in the following description.

The present invention is an improvement of said PERCEPTRAK system and disclosure.

Intelligent Video Events

In a current state-of-the-art intelligent video systems, such as the PERCEPTRAK system, individual targets (subjects of interest) are tracked in the video scene and their behavior is analyzed based on motion history and other symbolic data characteristics, including events, that are available from the video as disclosed in the PERCEPTRAK system disclosure.

Intelligent video systems such as the PERCEPTRAK system have had heretofore at most one mask to determine if a detected event should be reported (a so-called active mask).

A surveillance system disclosed in Venetianer et al. U.S. Pat. No. 6,696,945 employs what is termed a video “tripwire” where the event is generated by an object “crossing” a virtually-defined tripwire but without regard to the object's prior location history. Such a system merely recognizes the tripwire crossing movement, rather than tracking a target so crossing, and without taking into any consideration tracking history of targets or activity of subjects of interest within a sector, region or area of the image. Another basic difference between line crossing and the multiple mask concept of the present invention is the distinction between lines (with a single crossing point) and areas where the areas may not be contiguous. It is possible for a subject of interest to have been in a public mask and then take multiple paths to the secure mask.

### SUMMARY OF THE INVENTION

In view of the foregoing, it can be understood that it would be advantageous for an intelligent video surveillance system to provide not only current event detection as well as active area masking but also to provide means and capability to analyze and report on behavior based on the location of a target (subject of interest) at the time of behavior for multiple events and to so analyze and report based on the target location history.

Among the several objects, features and advantages of the invention may be noted the provision of a system and methodology which provides a capability for the use of multiple masks to divide the scene into logical areas along with the means to detect behavior events and adds a flexible logic inference engine in line with the event detection to configure and determine complex combinations of events and locations.

Briefly, an intelligent video system as configured in accordance with the invention captures video of scenes and provides software-implemented segmentation of targets in said scenes based on processor-implemented interpretation of the content of the captured video. The system is an improvement therein comprising software implementation for:

providing a configurable logic inference engine;

establishing masks for a video scene, the masks defining areas of the scene in which a logic-defined events may occur;

establishing at least one Boolean equation for analysis of activities in the scenes relative to the masks by the logic inference engine mask according to rules established by the Boolean equation; and

a user input interface providing preselection of the rules by a user of the system according to possible activity in the areas defined by the masks;

the logic inference engine using such Boolean equation to report to a user of the system the logic-defined events, thereby indicative of what, when and where a target has activities in one or more of the areas.

Thus, the logic inference engine or module reports within the system the results of the analysis, so as to allow reporting to a user of the system, such as a security guard, the logic-defined events as indicative of what, when and where a target has activities in one or more of the areas. The logic-defined event is a behavioral event connoting behavior, activities, characteristics, attributes, locations and/or patterns of a target subject of interest, and further comprises a user interface for allowing user selection of such behavior events for logic definition by the Boolean equation in accordance with a perceived advantage, need or purpose arising from context of system use.

Considered in another way, the invention provides a method of implementing complex behavior recognition in an intelligent video system, such as the PERCEPTRAK system, including detection of multiple events which are defined activities of subjects of interest in different areas of the scene, where the events are of interest for behavior recognition and reporting purposes in the system. The method comprises:

creating one or more of multiple possible masks defining areas of a scene to determine where a subject of interest is located;

setting configurable time parameters to determine when such activity occurs; and

using a configurable logic inference engine to perform Boolean logic analysis based on a combination of such events and masks.

According to a system aspect, the invention is used in a system for capturing video of scenes, including a processor-controlled segmentation system for providing software-implemented segmentation of subjects of interest in said scenes based on processor-implemented interpretation of the content of the captured video, and is an improvement comprising software implementation for:

providing a configurable logic inference engine;

establishing at least one mask for a video scene, the mask defining at least one of possible types of areas of the scene where a logic-defined event may occur;

creating a Boolean equation for analysis of activities relative to the at least one mask by the logic inference engine mask according to rules established by the Boolean equation;

providing preselection of the rules by a user of the system according what, when and where a subject of interest might have an activity relative to the at least one of possible types of areas;

analysis by the logic inference engine in accordance with the Boolean equation of what, when and where subjects of interest have activities in the at least one of possible types of areas; and

reporting within the system the results of the analysis so to inform thereby a user of the system what, when and where a target, i.e., a subject of interest, has or did have an activity or event in any of such areas.

The invention thus allows an open-ended means of detecting complex events as a combination of individual behavior events and locations. For example, such a complex event is described in this descriptive way:
A person entered the scene in Start Area One, passed through a Public area moving fast, and then entered Secure Area while there were no vehicles in Destination Area Two.

Events detected by the intelligent video system can vary widely by system but for the purposes of this invention the following list from the previously referenced the PERCEPTRAK system include the following events or activities or attributes or behaviors of subjects of interest (targets), and for convenience may be referred to as “behavioral events”:

SINGLE_PERSON

MULTIPLE_PEOPLE

CONVERGING_PEOPLE

FAST_PERSON

FALLEN_PERSON

ERRATIC_PERSON

LURKING_PERSON

SINGLE_CAR

MULTIPLE_CARS

FAST_CAR

SUDDEN_STOP_CAR

SLOW_CAR

STATIONARY_OBJECT

ANY_MOTION

CROWD_FORMING

CROWD_DISPERSING

COLOR_OF_INTEREST_{—}1

COLOR_OF_INTEREST_{—}2

COLOR_OF_INTEREST_{—}3

WALKING_GAIT

RUNNING_GAIT

ASSAULT_GAIT

These behavioral events of subjects of interest are combined with locations defined by mask configuration to add the dimension of “where” to a “what” dimension of the event. Note that an example, described herein, of assigning symbols advantageously includes examples of a target that “was in” a given mask and so adds an additional dimension of “when” to the equation. A representative sample of named masks is shown below but is not intended to limit the invention to only these mask examples:

| | |
|---|---|
| ACTIVE | Report events from this area |
| PUBLIC | Non-restricted area |
| SECURE | Restricted access area |
| FIRST_SEEN | Area of interest for first entry of |
| | scene |
| LAST_SEEN | Area of interest for leaving the |
| | scene |
| START_1 | 1^{st} area for start of a pattern |
| START_2 | 2^{nd} area for start of a pattern |
| START_3 | 3^{rd} area for start of a pattern |
| DEST_1 | 1^{st} area for destination of a pattern |
| DEST_2 | 2^{nd} area for destination of a pattern |
| DEST_3 | 3^{rd} area for destination of a pattern |

It will be appreciated that many other characteristics, attributes, locations, patterns and mask elements or events in addition to the above may be selected, as by use of the GUI ((Graphical User Interface) herein described, for logic definition by the Boolean equation in accordance with a perceived advantage, need or purpose arising from context of system use.

Definitions Used Herein

Boolean Notation

A technique of expressing Boolean equations with symbols and operators. The basic operators are OR, AND, and NOT using the symbols shown below.

+=OR operator, where (A+B) is read as A or B

•=AND operator, where (A•B) is read as A and B

\overline{A}=NOT operator, where (\overline{A}+B) is read as (Not A) or (B)

CCTV

Closed Circuit Television; a television system consisting of one or more cameras and one or more means to view or record the video, intended as a “closed” system, rather than broadcast, to be viewed by only a limited number of viewers.

Intelligent Video System

A coordinated intelligent video system, as provided by the present invention, comprises one or more computers, at least one of which has at least one video input that is analyzed at least to the degree of tracking moving objects (targets), i.e., subjects of interest, in the video scene and recognizing objects seen in prior frames as being the same object in subsequent frames. Such an intelligent video system, for example, the PERCEPTRAK system, has within the system at least one interface to present the results of the analysis to a person (such as a user or security guard) or to an external system.

Mask

As used in this document a mask is an array of contiguous or separated cells each in a rows and column aligned with and evenly spaced over an image where each cell is either “On” or “Off” and with the understanding that the cells must cover the entire scene so that every area of the scene is either On or Off. The cells, and thus the mask, are user defined according to GUI selection by a user of the system. The image below illustrates a mask of 32 columns by 24 rows. The cells where the underlying image is visible are “On” and the cells with a fill concealing the image are “Off. The areas defined by “Off” cells do not have to be contiguous. The areas defined by “On” cells do not have to be contiguous. The array defining or corresponding to an area image may be one of multiple arrays, and such arrays need not be contigous.

As used in this document a mask is an array of contiguous or separated cells each in a rows and column aligned with and evenly spaced over an image where each cell is either “On” or “Off”. The cells, and thus the mask, are user defined according to GUI selection by a user of the system. The image below illustrates a mask of 32 columns by 24 rows. The cells where the underlying image is visible are “On” and the cells with a fill concealing the image are “Off. The array defining or corresponding to an area image may be one of multiple arrays, and such arrays need not be contiguous.

Scene

The area/areas/portions of areas within view of one or more CCTV cameras (Virtual View). Where a scene spans more than one camera, it is not required that the views of the cameras be contiguous to be considered as portions of the same scene. Thus area/areas/portions of areas need not be contiguous.

Target

An object or subject of interest that is given a unique Target Number and tracked while moving within a scene while recognized as the same object. A target may be real, such as a person, animal, or vehicle, or may be a visual artifact, such as a reflection, shadow or glare.

Video

A series of images (frames) of a scene in order of time, such as 30 frames per second for broadcast television using the NTSC protocol, for example. The definition of video for this document is independent of the transport means, or coding technique. For example, video may be broadcast over the air, connected as baseband as over copper wires or fiber, or digitally encoded and communicated over a computer network. Intelligent video as here employed involves analyzing the differences between frames of video frames independently of the communication means.

Virtual View

The field of view of one or more CCTV cameras that are all assigned to the same scene for event detection. Objects are recognized in the different camera views of the Virtual View in the same manner as in a single camera view. Target ID Numbers assigned when a target is first recognized are used for the recognized target when it is in another camera view. Masks of the same name defined for each camera view are recognized as the same mask in the Boolean logic analysis of the events.

Software

The general term “software” is herein simply intended for convenience to mean programs, programming, program instructions, code or pseudo code, process or instruction sets, source code and/or object code processing hardware, firmware, drivers and/or utilities, and/or other digital processing devices and means, as well as software per se.

### BRIEF DESCRIPTION OF THE DRAWINGS

FIG. 1 is an example of one of possible masks used in implementing the present invention.

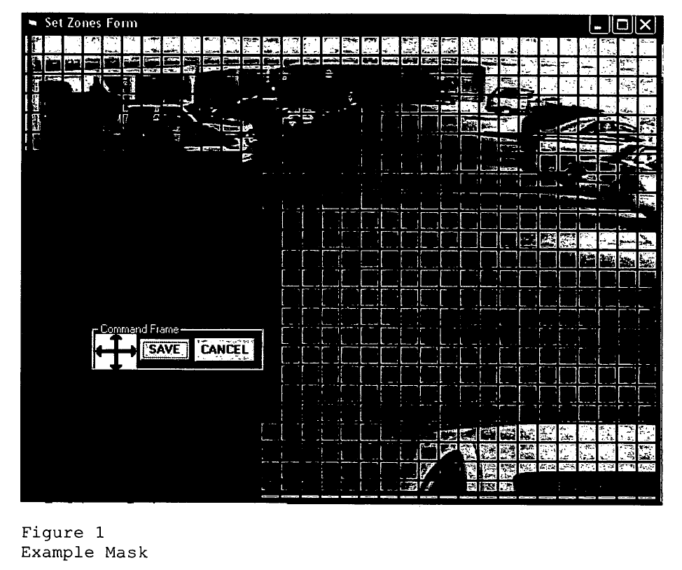

FIG. 2 is a Boolean equation input form useful in implementing the present invention.

FIG. 3 is an image of a perimeter fence line where the area to the right of the fence line is a secure area, and the area to the left is public. The line from the public area to the person in the secure area was generated by the PERCEPTRAK disclosure as the person was tracked across the scene.

FIG. 4 shows a mask of the invention called Active Mask.

FIG. 5 shows a mask of the invention called Public Mask.

FIG. 6 shows a mask of the invention called Secure Mask.

FIG. 7 is an actual surveillance video camera image.

FIG. 8 shows an Active Area Mask for the scene of that image.

FIG. 9 is the First Seen Mask that could be employed for the scene of FIG. 7.

FIG. 10 is a Destination Area Mask of the scene of FIG. 7.

FIG. 11 is what is termed a Last Seen Mask for the scene of FIG. 7.

This patent or application file contains at least one drawing executed in color. Copies of this patent or patent application publication with color drawing(s) will be provided by the Office upon request and payment of the necessary fee.

### DETAILED DESCRIPTION OF PRACTICAL EMBODIMENTS

The above-identified PERCEPTRAK system brings about the attainment of a CCTV security system capable of automatically carrying out decisions about which video camera should be watched, and which to ignore, based on video content of each such camera, as by use of video motion detectors, in combination with other features of the presently inventive electronic subsystem, thus achieving a processor-controlled selection and control system (“PCS system”), which serves as a key part of the overall security system, for controlling selection of the CCTV cameras. The PCS system is implemented in order to enable automatic decisions to be made about which camera view should be displayed on a display monitor of the CCTV system, and thus watched by supervisory personnel, such as a security guard, and which video camera views are ignored, all based on processor-implemented interpretation of the content of the video available from each of at least a group of video cameras within the CCTV system.

Included as a part of the PCS system are novel image analysis techniques which allow the system to make decisions about which camera an operator should view based on the presence and activity of vehicles and pedestrians. Events are associated with both vehicles and pedestrians and include, but are not limited to, single pedestrian, multiple pedestrians, fast pedestrian, fallen pedestrian, lurking pedestrian, erratic pedestrian, converging pedestrians, single vehicle, multiple vehicles, fast vehicles, and sudden stop vehicle.

The image analysis techniques are also able to discriminate vehicular traffic from pedestrian traffic by tracking background images and segmenting moving targets. Vehicles are distinguished from pedestrians based on multiple factors, including the characteristic movement of pedestrians compared with vehicles, i.e. pedestrians move their arms and legs when moving and vehicles maintain the same shape when moving. Other factors include the aspect ratio and smoothness, for example, pedestrians are taller than vehicles and vehicles are smoother than pedestrians.

The primary image analysis techniques of the PERCEPTRAK system are based on an analysis of a Terrain Map. Generally, the function herein called Terrain Map is generated from at least a single pass of a video frame, resulting in characteristic information regarding the content of the video. Terrain Map creates a file with the characteristic information based on each of the 2×2 kernels of pixels in an input buffer, which contains six bytes of data describing the relationship of each of sixteen pixels in a 4×4 kernel surrounding the 2×2 kernel.

The informational content of the video generated by Terrain Map is the basis for all image analysis techniques of the present invention and results in the generation of several parameters for further image analysis. The parameters include: (1) Average Altitude; (2) Degree of Slope; (3) Direction of Slope; (4) Horizontal Smoothness; (5) Vertical Smoothness; (6) Jaggyness; (7) Color Degree; and (8) Color Direction.

The PCS system as contemplated by the PERCEPTRAK disclosure comprises seven primary software components:

Analysis Worker(s)

Video Supervisor(s)

Video Worker(s)

Node Manager(s)

Administrator (Set Rules) GUI (Graphical User Interface)

Arbitrator

Console

The PCS system as contemplated by the PERCEPTRAK disclosure comprises six primary software components:

Analysis Worker(s)

Video Supervisor(s)

Video Worker(s)

Node Manager(s)

Set Rules GUI (Graphical User Interface); and

Arbitrator

Such a system is improved by employing, in accordance with the present disclosure, a logic inference engine capable of handling a Boolean equation of indefinite length. A simplified example in Equation 1 below is based on two pairs of lists. Each pair has a list of values that are all connected by the And operator and a list of values that are connected by the OR operator. Each pair of lists is connected by a configurable AND/OR operator and the intermediate results of each pair are connected by a configurable AND/OR operator. The equation below is the generalized form where the tilde (˜) represents an indefinite number of values, (+/•) represents a configurable selection of either the AND operator or the OR operator. The NOT operators (\overline{A}) are randomly applied in the example to indicate that any value in the equation can be either in its “normal” state or its inverted state as according to a NOT operator.

$$( ( A + B ∼ + G ) + \text{/} • ( \overline{C} • D • ∼ \overline{E} ) ) + \text{/} • ( ( \overline{F} + H + ∼ K ) + \text{/} • ( L • M • ∼ W ) )$$

$$Or List \qquad And List \qquad Or List \qquad And List$$

$$First Pair of Lists \qquad Second Pair of Lists$$

While the connector operators in Equation 1 are shown as configurable as either the AND or OR operators, the concept includes other derived Boolean operators including the XOR, NAND, and NOR gates.

For ease of Boolean notation mask status of targets and the results of target event analysis are assigned to single character or target symbols according to descriptions and event derivations such as the following.

| Symbol | Description | Derivation |
|---|---|---|
| A = | In the Active Mask Area | ACTIVE Mask |
| B = | In the Public Mask Area | PUBLIC Mask |
| C = | Has been in the Public Mask | PUBLIC Mask |
| | Area | |
| D = | In the Secure Mask Area | SECURE Mask |
| E = | Has been in the Secure Mask | SECURE Mask |
| | Area | |
| F = | Entered Scene in First Seen | FIRST_SEEN Mask |
| | Mask Area | |
| G = | Exited scene from Last Seen | LAST_SEEN Mask |
| | Mask area | |
| H = | In the 1^{st} Start Mask Area | START_1 Mask |
| I = | Has been in the First Start | START_1 Mask |
| | Mask Area | |
| J = | In the 2d Start Mask Area | START_2 Mask |
| K = | Has been in 2d Start Mask Area | START_2 Mask |
| L = | In the 3^{rd} Start Mask Area | START_3 Mask |
| M = | Has been in 3^{rd} Start Mask Area | START_3 Mask |
| N = | In 1^{st} Destination Mask Area | DEST_1 Mask |
| O = | Has been in 1^{st} Destination | DEST_1 Mask |
| | Mask Area | |
| P = | In 2d Destination Mask Area | DEST_2 Mask |
| Q = | Has been in 2d Destination | DEST_2 Mask |
| | Mask Area | |
| R = | In the 3^{rd} Destination Mask Area | DEST_3 Mask |
| S = | Has been in 3^{rd} Destination | DEST_3 Mask |
| | Mask Area | |
| T = | Target is a Person | SINGLE_PERSON Event |
| U = | Target is a Car | SINGLE_CAR Event |
| V = | Target is a Truck | SINGLE_TRUCK Event |
| W = | Target is moving Fast | FAST Event |
| X = | Target is moving Slow | SLOW Event |
| Y = | Target is Stationary | STATIONARY Event |
| Z = | Target Stopped Suddenly | SUDDEN_STOP Event |
| a = | Target is Erratic | ERRATIC_PERSON Event |
| b = | Target Converging with another | CONVERGING Event |
| c = | Target has fallen down | FALLEN_PERSON Event |
| d = | Crowd of people forming | CROWD_FORMING Event |
| e = | Crowd of people dispersing | CROWD_DISPERSE Event |
| f = | Color of Interest one | COLOR_OF_INTEREST_1 |
| g = | Color of Interest two | COLOR_OF_INTEREST_2 |
| h = | Color of Interest three | COLOR_OF_INTEREST_3 |
| i = | Gait of walking person | WALKING_GAIT |
| j = | Gait of running person | RUNNING_GAIT |
| k = | Crouching combat style gait | ASSAULT_GAIT |

### Logic Inference Engine

The Logic Inference Engine (LIF) or module (LIM) of the PERCEPTRAK system evaluates the states of the associated inputs based on the rules defined in the PtrakEvent structure. If all of the rules are met the LIF returns the output True.

The system need not be limited to a single LIF, but a practical system can employ with advantage a single LIF. All events are constrained by the same rules so that a single LIF can evaluate all current and future events monitored and considered by the system. Evaluation, as according to the rules established by the Boolean equation of evaluating an event, yields a logic-defined event (“Logic Defined Event”), which is to say an activity of a subject of interest (target) which the system can report in accordance with the rules preselected by a user of the system.

In this example, events are limited for convenience to four lists of inputs organized as two pairs of input lists. Each pair has a list of inputs that are connected by AND operators and one list of inputs that are connected by OR operators. There is no arbitrary limit to the length of the lists, but the GUI design will, as a practical matter, dictate some limit.

The GUI should not present the second pair of lists until the first pair has been configured. The underlying code will assume that if the second pair is in use then the first pair must also be in use.

Individual inputs in all four lists can be evaluated in either their native state or inverted to yield the NOT condition. For example, TenMinTimeTick and NOT SinglePerson with a one hour valid status will detect that an hour has passed without seeing a roving security guard.

Inputs do not have to be currently True to be evaluated as True by the LIF. The parameter ValidTimeSpan can be used to control the time that inputs may be considered as True. For example if ValidTimeSpan is set to 20, a time in seconds, any input that has been True in the last 20 seconds is still considered to be True.

Each pair of lists can be logically connected by an AND operator, an OR operator, or an XOR operator, to yield two results. The two results may be connected by either an AND operator, and OR operator or an XOR operator to yield the final result of the event evaluation.

Prior to evaluation each input is checked for ValidTimeSpan. Each input is considered True if it has been True within ValidTimeSpan.

If the List2Last element of PtrakEvent is True the oldest input from the second pair of lists must be newer (or equal using the Or Equal operator) than the newer input of the first pair of lists. This conditions allows specifying events where inputs are required to “fire” (occur) in a particular order rather than just within a given time in any order.

After normalization for valid time span, each input is normalized for the NOT operator. The NOT operator can be applied to any input in any list allowing events such as EnteredStairway AND NOT ExitedStairway. The inversion can be performed by XORing with the Inverted (NOT) operator for that input. If one of the inputs and Inverted is True but not both True then the input is evaluated in the following generic Boolean equation as True.
ThisEvent.EventState=(AndIn1 AND AndIn2 AND AndIn3 . . . ) AND/OR (OrIn1 OR OrIn2 OR OrIn3 . . . )
AND/OR
(AndIn4 AND AndIn5 AND AndIn6 . . . ) AND/OR (OrIn4 OR OrIn5 OR OrIn6 . . . ) (Equation 2)

If EventState is evaluated as True then the Logic Defined Event is considered to have “fired”.

PtrakEventInputs Array

An array identified as PtrakEventInputs contains one element for each possible input in the system such as identified above with the symbols A to K. Each letter symbol is mapped to a Flat Number for the array element. For example A=1, B=2, etc.

The elements are of type PtrakEventInputsType as defined below.
Public Type PtrakEventInputsType
CurrentState As Boolean Either the input is on or off right now.
LatchSeconds As Long If resets are not reported then CurrentState of True is valid only LatchSeconds after LastFired.
LastFired As Date Time/Date for the last time the input fired, went True.
LastReset As Date Time/Date for the last time the input reset, back to false.
FlatInputNum As Long Sequential input number assigned to this input programmatically for finding in an array.
RecordIdNum As Long Autonumbered Id for the record where this input is saved.
EventsUsingThisInput( ) As Long Programmatically assigned array of the flat event number of events using this input.
   End Type

After the Boolean equation is parsed, a structure is filled out to map the elements of the equation to common data elements for all events. This step allows a common LIF to evaluate any combination of events. The following is the declaration of the event type structure.

Public Type PtrakEventType

Enabled As Boolean True if the event is enabled at the time of checking.
LastFired As Date Time/Date for the last time the event fired.
LastChecked As Date Time/Date for the last time the event state was checked.
ValidTimeSpan As Long Maximum seconds between operation of associated inputs. For example, 2 seconds.
ScheduleId As Long Identifier for a time/date schedule for this event to follow for enabled/disabled.
List2Last As Boolean If True the oldest input (“Oldest”) from the second lists must be newer than the newest of the first lists.
ListOfAnds1( ) As Long List one of inputs that get anded together.
ListOfAnds1Len As Long Number of inputs listed in ListOfAnds1
ListOfAnds1Inverted( ) As Boolean One-to-one for ListOfAnds1, each element True to invert (NOT) the element of ListOfAnds1.
ListOfOrs1( ) As Long List one of inputs that get ORed together.
ListOf Ors1Len As Long Number of inputs listed in ListOfOrs1
ListOfOrs1Inverted( ) As Boolean One-to-one for ListOfOrs1, each element True to invert (NOT) the element of ListOfOrs1.
ListOfAnds2( ) As Long List 2 of inputs that get anded together.
ListOfAnds2Len As Long Number of inputs listed in ListOfAnds2
   End Type
ListOfAnds2Inverted( ) As Boolean One-to-one for ListOfAnds2, each element True to invert (NOT) the element of ListOfAnds2.
ListOfOrs2( ) As Long List 2 of inputs that get ORed together.
ListOf Ors2Len As Long Number of inputs listed in ListOfOrs2
ListOfOrs2Inverted( ) As Boolean One-to-one for ListOfOrs2, each element True to invert (NOT) the element of ListOfOrs2.
List1Operator As Long Operator connecting ListOfAnds1 and ListOfOrs1, value is either USE_AND OR USE_OR OR USE_XOR.
List2Operator As Long Operator connecting ListOfAnds2 and ListOfOrs2, value is either USE_AND OR USE_OR OR OR USE_XOR.
Lists1To2Operator As Long Operator connecting List1Operation and List2Operation, value is either USE_AND OR USE_OR OR OR USE_XOR.
EventState As Boolean Result of checking the inputs the last time.
OutputListId( ) As Long The list of outputs to fire when this event fires. One element per.
UseMessageOfFirstTrueInput As Boolean If True then the event message is from the message of the first entered input that's True.
Message As String The text message associated with the event. If NOT UseMessageOfFirstTrueInput then enter here.
Priority As Long LOW, MEDIUM, OR HIGH are allowed values.
FlatEventNumber As Long Sequential zero based flat number assigned programmatically for array element
   End Type
   Graphical User Interface

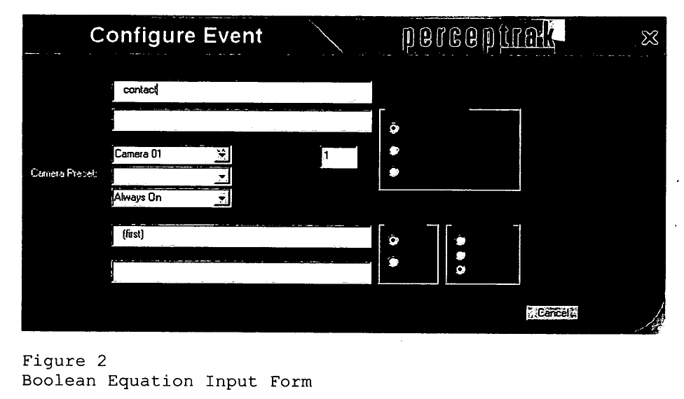

A graphical user interface (GUI) is employed. It includes forms to enter events, and mask names and configurable times to define a Boolean Equation from which an LIF will evaluate any combination of events. FIG. 2 illustrates the GUI, which is drawn from aspects of the PERCEPTRAK disclosure. The GUI is used for entering equations into the event handler. Thus, the GUI is a user input interface providing preselection of the rules by a user of the system according to possible activity in the areas defined by the masks.

Configuration Variables

In order to allow configuration of different cameras to respond to behavior differently, individual cameras used as part of the PERCEPTRAK system can have configuration variables assigned to program variables from a database at process start up time. Following are some representative configuration variables and so-called constants, with comments on their use in the system.

Constants for Mask Timing

SECS_TO_HOLD_WAS_IN_ACTIVE_MASK=10 means that if a target was in the mask in the last ten seconds then WasInMask is True.
SECS_TO_HOLD_WAS_IN_PUBLIC_MASK=10 means that if a target was in the mask in the last ten seconds then WasInMask is True.
SECS_TO_HOLD_WAS_IN_SECURE_MASK=10 means that if a target was in the mask in the last ten seconds then WasInMask is True.
SECS_TO_HOLD_WAS_IN_DEST1_MASK=10 means that if a target was in the mask in the last ten seconds then WasInMask is True.
SECS_TO_HOLD_WAS_IN_DEST2_MASK=10 means that if a target was in the mask in the last ten seconds then WasInMask is True.
SECS_TO_HOLD_WAS_IN_DEST3_MASK=10 means that if a target was in the mask in the last ten seconds then WasInMask is True.
SECS_TO_HOLD_WAS_IN_STARTAREA1_MASK=10 means that if a target was in the mask in the last ten seconds then WasInMask is True.
SECS_TO_HOLD_WAS_IN_STARTAREA2_MASK=10 means that if a target was in the mask in the last ten seconds then WasInMask is True.
SECS_TO_HOLD_WAS_IN_STARTAREA3_MASK=10 means that if a target was in the mask in the last ten seconds then WasInMask is True.
   Constants for Fast Movement of Persons
WIDTHS_SPEED_FOR_FAST_PERSON=2 means 2 widths/sec or more is a fast Person
HEIGHTS_SPEED_FOR_FAST_PERSON=0.4 means 0.4 heights/sec or more is a fast Person
MIN_SIZE_FOR_FAST_PERSON=1 means if Person is less than 1% of screen don't look for sudden stop
SIZE_DIFF_FOR_FAST_PERSON=2 means if size diff from 3 sec ago is more than 2 it is a segmentation problem, don't check
SPEED_SUM_FOR_FAST_PERSON=Sum of x, y, and z threshold
Z_PCT_THRESHOLD
MAX_ERRATIC_BEHAVIOR_FOR_FAST_PERSON=Threshold to ignore false event
   Constants for Fast and Sudden Stop Cars
WIDTHS_SPEED_FOR_FAST_CAR=0.3 means 0.3 widths/sec or more is a fast car
HEIGHTS_SPEED_FOR_FAST_CAR=0.4 means 0.4 heights/sec or more is a fast car
XY_SUM_FOR_FAST_CAR
MIN_WIDTHS_SPEED_BEFORE_STOP 0.2 means 0.2 widths/sec is minimum reqd speed for sudden stop
MIN_HEIGHTS_SPEED_BEFORE_STOP=0.3 means 0.3 heights/sec is minimum reqd speed for sudden stop
SPEED_FRACTION_FOR_SUDDEN_STOP=0.4 means 0.4 of fast speed is sudden stop
STOP_FRACTION_FOR_SUDDEN_STOP=0.4 means speed must drop 40% of prior
MIN_SIZE_FOR_SUDDEN_STOP=1 means if car is less than 1% of screen don't look for sudden stop
MAX_SIZE_FOR_SUDDEN_STOP
XY_SPEED_FOR_SLOW_CAR
SECONDS_FOR_SLOW_CAR
SIZE_DIFF_FOR_FAST_CAR=2 means if size diff from 5 sec ago is more than 2 it is a segmentation problem, don't check
   Constants for Putting Non-Movers in the Background
PEOPLE_GO_TO_BACKGROUND_THRESHOLD=seconds to pass before putting non-mover in background
CARS_GO_TO_BACKGROUND_THRESHOLD=short periods for testing testing should
NOISE_GOES_TO_BACKGROUND_THRESHOLD
ALL_TO_BACKGROUND_AFTER_NEW_BACKGROUND
SECS_FOR_FASTER_GO_TO_BACKGROUND=Secs after new background to use all to background threshold
   Checks for Fallen or Lurking Person Constants
FALLEN_THRESHOLD=Higher to get fewer fallen person events
STAYING_DOWN_THRESHOLD=Higher to require staying down longer for fallen person event
LURKING_SECONDS=More than this a person is considered lurking
   Constants for Check for Converging
MIN_WIDTHS_APART_BEFORE_CONVERGING=Relative to centers 3 here means there was two widths between two people when they were first seen
MIN_HEIGHTS_APART_BEFORE_CONVERGING=Relative to centers 2 here means there was one height between two people when they were first seen
WIDTHS_APART FOR_CONVERGED=From nearest side to nearest side in terms of average widths
MAX_HEIGHT_DIFF_FOR_CONVERGED=2 here means that the tallest height cannot be more than 2*the shortest height
TOPS_APART_FOR_CONVERGED=Relative to the height of the tallest target 0.5 here means that to be considered converging the distance between the two tops cannot be more than ⅓ of the height of the taller target.
   Constants for Erratic Behavior or Movement
ERRATIC_X_THRESHOLD=If the gross X movement is more than this ratio of net X then Erratic
ERRATIC_Y_THRESHOLD=If the gross Y movement is more than this ratio of net Y then Erratic
MIN_SECS_BEFORE_ERRATIC
MIN_HEIGHTS_MOVE_BEFORE_ERRATIC=Reqd gross Y movement before checking for erratic
MIN_WIDTHS_MOVE_BEFORE_ERRATIC=Reqd gross X movement before checking for erratic
SECS_BACK_TO_LOOK_FOR_ERRATIC=Only look this far back in history for erratic behavior
   Constants to Decide Whether or not to Report the Target
MIN_AREA_PERCENT_CHANGE=If straight to or from camera only area changes
MIN_PERSON_WIDTHS_MOVEMENT=Person must have either X or Y movements of these constants to be reported
MIN_PERSON_HEIGHTS_MOVEMENT
MIN_CAR_WIDTHS_MOVEMENT=Car must have either X or Y movements
MIN_CAR_HEIGHTS_MOVEMENT
REPORTING_PERSON_INTERVAL_SECONDS
REPORTING_VEHICLE_INTERVAL_SECONDS
REPORTING_PERSON_DELAY_SECONDS
REPORTING_VEHICLE_DELAY_SECONDS
TINY_THRESHOLD=Less than this percent of screen should not be scored
   Detect Motion
MOTION_XY_SUM
MOTION_MIN_SIZE
MOTION_REPORTING_INTERVAL_SECONDS
MOTION_REPORTING_DELAY_SECONDS
   Constants for Crowd Dispersal and Forming
MIN_COUNT_MEANING_CROWD=At least this many to mean a crowd exists
PERCENT_INCREASE_FOR_FORMING=Percent increase in time allowed to mean crowd formed
MINUTES_FOR_INCREASE=Percent increase must happen within this many mins
SECS_BETWEEN_FORMING_REPORTS=Don't repeat the report for this many seconds
PERCENT_DECREASE_DISPERSED=At least this percentage decrease in time allowed
MINUTES_FOR_DECREASE=mins allowed for percentage decrease
SECS_BETWEEN_DISPERSE_REPORTS=Don't repeat the report for this many seconds.
PERSON_PERCENT_BOT_SCREEN=Percent screen (mass) of a person at the bottom of the screen
PERSON_PERCENT_MID_SCREEN=Percent Screen (mass) of a person at mid screen
MINIMUM_PERSON_SIZE=0.1=Don't use less than one tenth of a percent for expected person size.
   Constants for Wrong Way Motion
DETECT_WRONG_WAY_MOTION
WRONG_WAY_MIN_SIZE
WRONG_WAY_MAX_SIZE
WRONG_WAY_REPORTING_DELAY_SECONDS
SECONDS_BETWEEN_WRONG_WAY_REPORTS
   Constants for Long Term Tracking
STATIONARY_MIN_SIZE=In percent of screen, the smallest target to be tracked for the Stationary event.
STATIONARY_MAX_SECONDS=Denominated in seconds, more that this generates the Stationary event.
STATIONARY_SECONDS_TO_CHECK_AGAIN=every this seconds check the stationary
STATIONARY_MAX_TARGETS=The most targets expected, used to calculate OccupantsPastLength.
STATIONARY_MATCH_THRESHOLD=The return from CompareTargetsSymbolic, above this it is considered to be a match, probably about 80.
STATIONARY_REPORTING_INTERVAL_SECONDS Minimum interval between reporting stationary event
   Examples of Mask Assignment

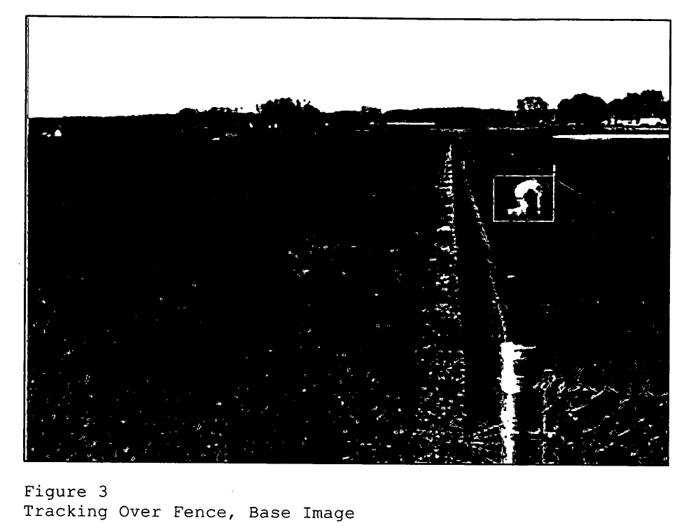

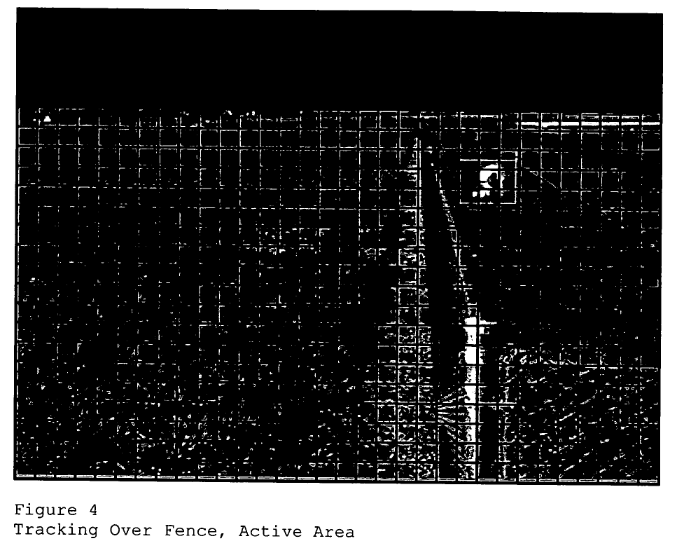

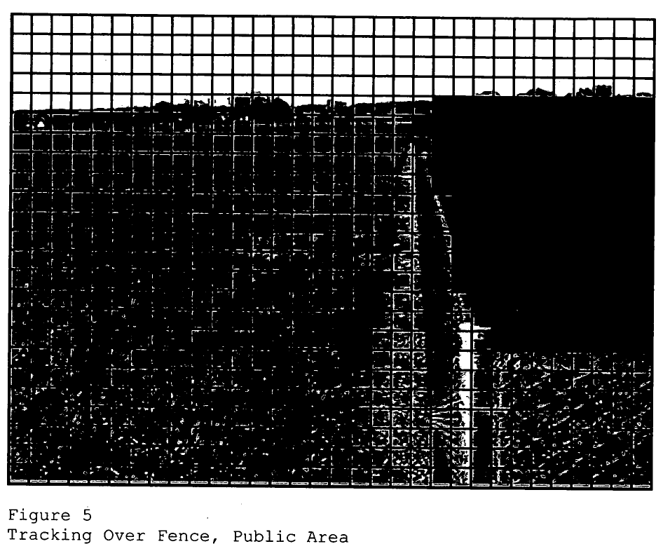

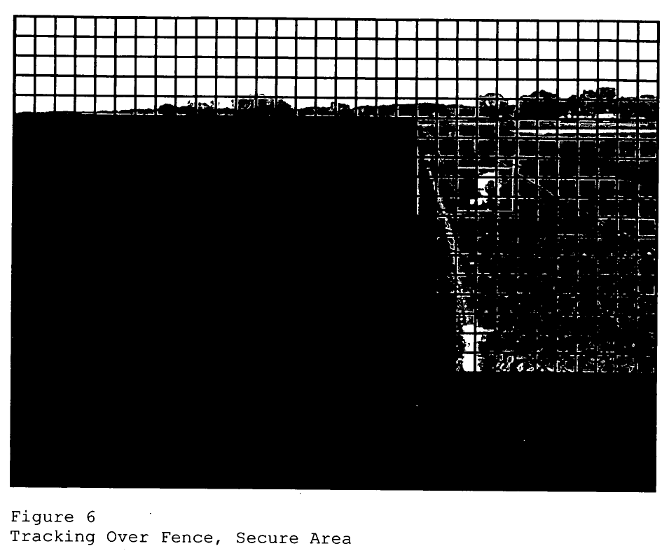

Mask assignment is carried out in accordance with a predetermined need for establishing security criteria within a scene. As an example, FIG. 3 is an image of a perimeter fence line, such as a provided by a security fence separating an area where public access is permitted from an area where not permitted. In FIG. 3, the visible area to the right of the fence line is a secure area, and visible area to the left is public. The line from the public area to a person in the secure area is shown generated by the PERCEPTRAK system as the person was tracked across the scene. Three masks are created: Active, Public and Secure. FIG. 4 shows the Active Mask. FIG. 5 shows the Public Mask. FIG. 6 shows the Secure Mask.

To generate a PERCEPTRAK event determinative of unauthorized entry for this scene, the following Boolean equation is to be evaluated by the PERCEPTRAK system.
(IsInSecureMask And IsInActiveMask And WasInPublicMask) (Equation 3)

In operation, solving of the Boolean equation (3) operating on the data masks by the Perceptrak system provides a video solution indicating impermissible presence of a subject in the private area. Further Boolean analysis by parsing by the above-identified constants for erratic behavior or movement, or other attributes of constants, indicates greater information about the subject, such as that the person is running. Tracking shows the movement of the person, who remains subject to intelligent video analysis.

Many other types of intelligent video analysis can be appreciated.

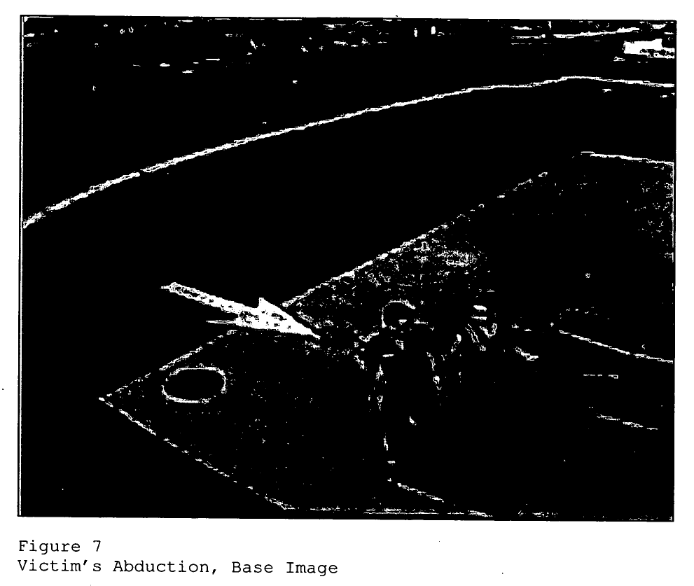

FIG. 7 is an actual surveillance video camera image taken at a commercial carwash facility at the time of abduction of a kidnap victim. The camera was used to obtain a digital recording not subjected to intelligent video analysis, that is to say, machine-implemented analysis. Images following illustrate multiple masks within the scope of the present invention that can be used to monitor normal traffic at said commercial facility and to detect the abduction event as it happened.

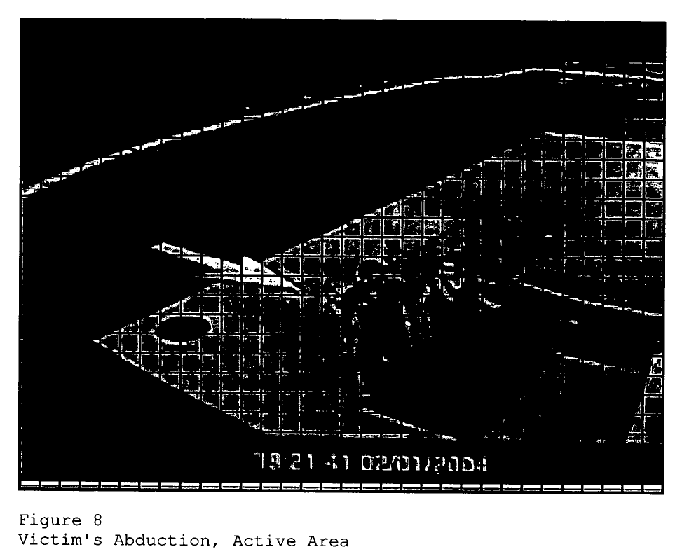

FIG. 8 shows an Active Area Mask. The abductor entered the scene from the bottom of the view. The abductee entered the scene from the top of the scene. There was a converging person event in the active area of the scene. A Converging People event in the active area would have fired for this abduction. For example, a converging person event with a prompt response might have avoided the abduction. Such determination can be made by the use of the above-identified checks for converging, lurking or fallen person constants.

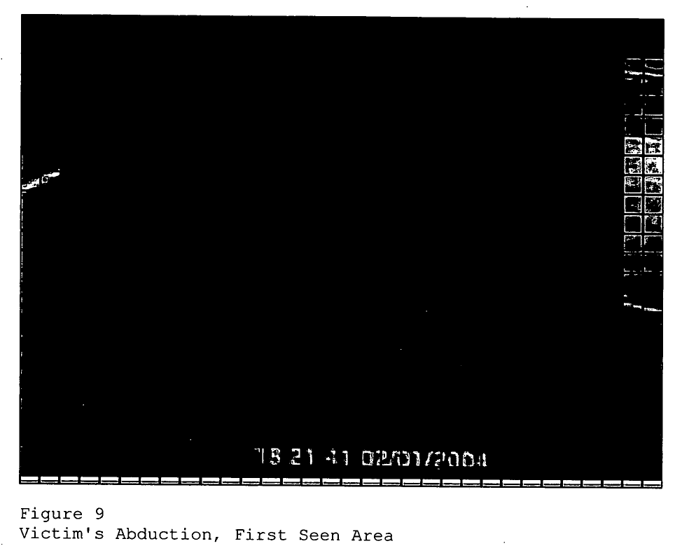

FIG. 9 is the First Seen Mask that could be employed for the scene of FIG. 7. If a target is in the active area but has not been seen in the active area mask then the PERCEPTRAK system can determine that an un-authorized entry has occurred.

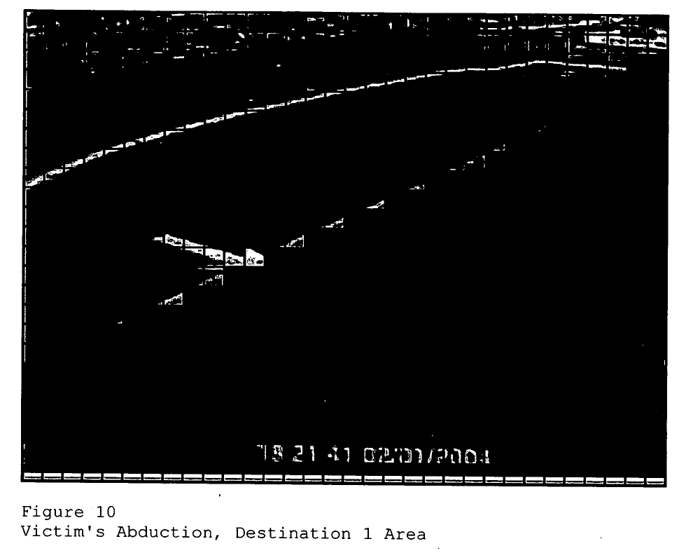

FIG. 10 is a Destination Area Mask of the scene of FIG. 7. If there are multiple vehicles in the Destination Area, then there is a line building up for the carwash commercial facility where the abduction took place, which the PERCEPTRAK system can recognize and report and thus give the availability of a warning or alert for the presence of greater numbers of persons who may be worthy of monitoring.

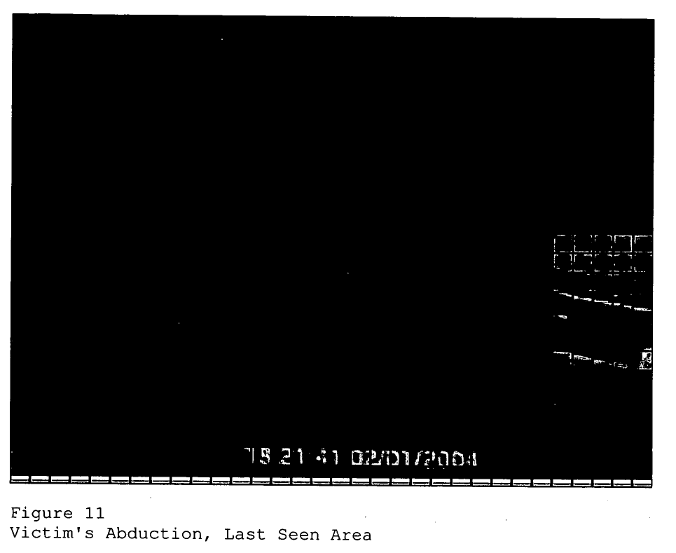

FIG. 11 is the Last Seen Mask for the scene of FIG. 7. If a car leaves the scene but was not last seen in the Last Seen Mask (entering the commercial car wash) then warning is provided that the lot is being used for through traffic, an event of security concern.

In view of the foregoing, one can appreciate that the several objects of the invention are achieved and other advantages are attained.

Although the foregoing includes a description of the best mode contemplated for carrying out the invention, various modifications are contemplated.

As various modifications could be made in the constructions and methods herein described and illustrated without departing from the scope of the invention, it is intended that all matter contained in the foregoing description or shown in the accompanying drawings shall be interpreted as illustrative rather than limiting.

What is claimed is:

1. In a system for capturing video of scenes, including a processor-controlled segmentation system for providing software-implemented segmentation of subjects of interest in said scenes based on processor-implemented interpretation of the content of the captured video, the improvement comprising software implementation for:
providing a configurable logic inference engine;
establishing at least one mask for a video scene, the mask defining at least one of possible types of areas of the scene where a logic-defined event may occur;
creating a Boolean equation for analysis of activities relative to the at least one mask by the logic inference engine mask according to rules established by the Boolean equation;
providing preselection of the rules by a user of the system according what, when and where a subject of interest might have an activity relative to the at least one of possible types of areas;
analysis by the logic inference engine in accordance with the Boolean equation of what, when and where subjects of interest have activities in the at least one of possible types of areas; and
reporting within the system the results of the analysis, whereby to report to a user of the system the logic-defined events as indicative of what, when and where a target has activities in one or more of the areas.

2. In a system as set forth in claim 1, wherein the logic-defined event is a behavioral event connoting behavior, activities, characteristics, attributes, locations or patterns of a target subject of interest, and further comprises a user interface for allowing user selection of such behavior events for logic definition by the Boolean equation in accordance with a perceived advantage, need or purpose arising from context of system use.

3. In a system as set forth in claim 1, wherein the at least one mask is one of a plurality of masks including a public area mask and a secure area mask which correspond respectively to a public area and a secure area of a scene.

4. In a system as set forth in claim 3, wherein the plurality of masks includes also an active area mask which corresponds to an area in which events are to be reported.

5. In a system as set forth in claim 3 wherein preselection of the rules by a user of the system defines whether a subject of interest should or should not be present in the secure area.

6. In a system as set forth in claim 3 wherein the logic-defined event is one of a predefined plurality of possible behavioral events of subjects of interest.

7. In a system as set forth in claim 3 wherein the logic-defined event is one of a predefined plurality of possible activities or attributes.

8. A method of implementing complex behavior recognition in an intelligent video system including detection of multiple events which are defined activities of subjects of interest in different areas of the scene, where the events are of interest for behavior recognition and reporting purposes in the system, said method comprising:
creating one or more of multiple possible masks defining areas of a scene to determine where a subject of interest is located;
setting configurable time parameters to determine when such activity occurs; and
using a configurable logic inference engine to perform Boolean logic analysis based on a combination of such events and masks.

9. A method as set forth in claim 8 wherein the events to be detected are those occurring in a video scene consisting of one or more camera views and considered to be a single virtual View.

10. A method as set forth in claim 8, the possible masks including a public area mask and a secure area mask which correspond respectively to
(a) a public or non-restricted access area mask and
(b) a secure or restricted access area mask.

11. A method as set forth in claim 10, the possible masks including also an active area mask which corresponds to (c) an area in which events are to be reported.

12. A method as set forth in claim 10, the possible masks including also
(d) first seen mask corresponding to area of interest for first entry of scene by a subject of interest;
(e) last seen mask corresponding to area of interest for leaving of a scene by a subject of interest;
(f) at least one start mask corresponding to area of interest for start of a pattern in a scene by a subject of interest; and
(g) at least destination mask corresponding to area of interest for a pattern destination in a scene by a subject of interest.

13. A method as set forth in claim 10 wherein the logic inference engine is caused to perform Boolean logic analysis according to rules, the method further comprising:
preselection of the rules by a user of the system to define whether a subject of interest should or should not be present in the secure area.

14. A method as set forth in claim 13 wherein the logic-defined event is a behavioral event connoting possible behavior, activities, characteristics, attributes, locations or patterns of a target subject of interest, and further comprising user entry a user interface for allowing a user of the system to select such behavior events for logic definition by the Boolean equation in accordance with a perceived advantage, need or purpose arising from context of system use.

15. A method as set forth in claim 10 wherein the defined activities of subjects of interest are user selected from a predefined plurality of possible behavioral events of subjects of interest.

16. A method as set forth in claim 10 wherein the possible behavioral events constitute possible activities or attributes of subjects of interest.

17. A method as set forth in claim 15 wherein the possible behavioral events of subject of interest which is a target comprises one or more of the following target descriptions:
a person; a car; a truck; target is moving fast; target is moving slow; target is stationary; target is stopped suddenly; target is erratic; target is converging with another; target has fallen down; crowd of people is forming; crowd of people is dispersing; has gait of walking person; has gait of running person; is crouching combat style gait; is a color of interest; and is at least another color of interest; and
wherein said target descriptions correspond respectively to event derivations comprising:
a single person event; a single car event; a single truck event; a fast event; a slow event; a stationary event; sudden stop event; an erratic person event; a converging event; a fallen person event; a crowd forming event; a crowd disperse event; a walking gait; a running gait; an assault gait; a first color of interest; and at least another color of interest.

18. A method as set forth in claim 8 wherein, for each of the mask-defined areas of the scene, events to be detected include whether a target: is in the mask area, has been in the mask area, entered the mask area, exited the mask area, was first seen entering the mask area, was last seen leaving the mask area, and has moved from the mask area to another mask area.

19. An intelligent video system for capturing video of scenes, the system providing software-implemented segmentation of targets in said scenes based on processor-implemented interpretation of the content of the captured video, the improvement comprising software implementation for:
providing a configurable logic inference engine;
establishing masks for a video scene, the masks defining areas of the scene in which a logic-defined events may occur;
establishing at least one Boolean equation for analysis of activities in the scenes relative to the masks by the logic inference engine mask according to rules established by the Boolean equation; and
a user input interface providing preselection of the rules by a user of the system according to possible activity in the areas defined by the masks;
the logic inference engine using such Boolean equation to report to a user of the system the logic-defined events as indicative of what, when and where a target has activities in one or more of the areas.

20. An intelligent video system as set forth in claim 19, the system comprising a plurality of individual video cameras, the system permitting different individual cameras to havec associated with them different configuration variables and associated constants assigned to program variables from a database,
whereby to allow different cameras to respond to behavior of targets differently.
